(19) United States
(12) Patent Application Publication
(10) Pub. No.: US 2022/0134604 A1
(43) Pub. Date: May 5, 2022

(54) METHOD FOR RECYCLING PLASTIC

(71) Applicant: VANBRIEL YUAN BVBA, Antwerpen (BE)

(72) Inventors: Joris VANBRIEL, Antwerpen (BE); Peng Yu YUAN, Antwerpen (BE)

(73) Assignee: VANBRIEL YUAN BVBA, Antwerpen (BE)

(21) Appl. No.: 17/435,472

(22) PCT Filed: Mar. 18, 2020
(86) PCT No.: PCT/IB2020/052469

§ 371 Date: Sep. 1, 2021

(30) Foreign Application Priority Data
Mar. 18, 2019 (BE) BE2019/5165

(51) Int. Cl. B29B 17/02; B29B 17/04; B29C 41/04

(52) U.S. Cl. CPC B29B 17/02; B29B 17/0412; B29C 41/04; B29K 2101/12; B29B 2017/0237; B29B 2017/0279; B29B 2017/042; B29B 2017/0203

(57) ABSTRACT

A method for recycling plastic such as plastic toys includes grinding the plastic into plastic pieces, sorting the plastic pieces based on type of plastic, sorting the plastic pieces based on colour, after sorting of the plastic pieces, shredding the sorted plastic pieces into plastic flakes, and processing the plastic flakes into a recycled good by means of rotational moulding. During the rotational moulding, a micronized plastic is added.

### FIELD OF THE INVENTION

The present invention relates to a method for recycling plastic, preferably recycling plastic toys.

### BACKGROUND

Depending on their use, plastic products are manufactured from thermoplastics or thermosets. Thermoplastics have the feature that, when exposed to heat, they become liquid. This effect is caused by the fact that thermoplastics are formed by molecular chains which are only bonded to each other by Van der Waals bonds. The Van der Waals bonds are broken when exposed to heat, whereby the individual chains can move along each other. A thermoplastic can thus melt. A thermoplastic can thus be recycled multiple times in simple manner. In the case of thermosets the molecular chains are interconnected. This interconnectedness is referred to as a cross-link The cross-links are covalent bonds which are many times stronger than the Van der Waals bonds. Because the molecular chains are cross-linked, a thermoset has a strong and rigid structure. When exposed to heat, the molecular chains can however not start to move relative to each other. Hereby, the thermosets retain their shape when exposed to heat. When heated, the covalent cross-links break, and the molecule chains are broken. A thermoset is thus decomposed into multiple lumps of smaller molecules. These molecules produce black, charred remnants and malodorous and combustible gases. This makes thermosets difficult to recycle. As a result, thermosets are often incinerated in an incinerator. Thermosets and thermoplastics are typically used for manufacturing toys. Such toys however have a relatively short lifespan and are difficult or impossible to recycle.

### SUMMARY OF THE INVENTION

Embodiments of the invention have the object of providing a method in order to obtain an improved recycling of plastic, preferably an improved recycling of plastic toys.

The invention provides for this purpose a method for recycling plastic, preferably recycling plastic toys. The method comprises the steps of:
grinding the plastic into plastic pieces;
sorting the plastic pieces based on type of plastic;
sorting the plastic pieces based on colour;
after sorting of the plastic pieces, shredding the sorted plastic pieces into plastic flakes;
processing the plastic flakes into a recycled good by means of rotational moulding, wherein, during the rotational moulding, a micronized plastic is added.

Toys can comprise various forms and can also be manufactured from different types of plastic. Because the plastic toy is ground into plastic pieces, the method provides a way of performing further steps on the plastic pieces in simpler and more efficient manner. The plastic pieces are sorted based on type, so that plastic pieces of a thermoplastic material, which was possibly also incorporated in the plastic toy, can be separated and can be recycled by means of known methods. A further advantage of the method is based on the insight that if a recycled good were to be made through addition of large plastic pieces, the recycled good has bad structural properties. After sorting of the plastic pieces, the plastic pieces are thus shredded into plastic flakes such that the further processing of plastic flakes into a recycled good is simplified and the quality of the recycled good is improved. Because a micronized plastic is added, a covalent cross-link results between the different plastic flakes, whereby the recycled good obtains an improved rigidity and strength. A further advantage is based on the insight that thermoplastics and thermosets, particularly thermoplastics, can only be recycled a finite number of times by means of common recycling processes. This is because the molecular chains shorten when thermoplastics melt in known recycling processes. Use of the method as described above allows the thermoplastics which can no longer be recycled to be recycled anyway, and preserves the properties of the thermoplastic. The method as described above thus provides for an improved recycling of plastic toys. Another additional effect is that further processing steps, such as for instance compounding into plastic granulates, wherein recycled plastics are mixed with new plastics, additives or pigments, are avoided.

According to an embodiment, the sorting of the plastic pieces based on colour comprises of subdividing the plastic pieces into groups according to a colour, wherein each group comprises plastic pieces having substantially the same colour as each other. In common recycling processes of thermoplastics a bleaching agent is added in order to remove the colour from the recycled thermoplastics. Bleaching processes typically work by breaking the chemical bonds forming the chromophore. The chromophore or colour carrier is the part of the molecule responsible for the absorption of light. The molecule hereby transforms into a different substance which comprises no chromophore, or which comprises a chromophore which does not absorb visible light. The safety of bleaching agents depends on the bonds present, and their concentration. Ingestion of bleaching agents can generally cause damage to the oesophagus and the stomach. The bleaching agents can cause irritation, drying and/or possible burns when they come into contact with the skin or eyes. Inhalation of bleach fumes can damage the lungs. The inventiveness of this solution is based inter alia on the insight that subdividing the plastic pieces into groups according to colour makes the step of bleaching redundant. Depending on the application and the intended object, the recycled goods can be manufactured from the plastic flakes from a determined colour group. Because no bleach residues can be present on the recycled good, the recycled good becomes safer for the end user and the method for recycling plastic is cheaper and safer. In further steps in known recycling processes a plurality of additives and/or colouring agents are added in order to obtain a uniform end product. Sorting based on colour makes these steps redundant and, as a result, the method provides for an improved recycling of plastics, particularly of plastic toys.

According to an embodiment, the colour of the plastic pieces is determined by means of spectral imaging. The method can hereby collect image data in visible and non-visible bands simultaneously, and capture wavelength bands for each pixel in an image. This reduces the chance of false positives in the sorted groups. This means that no or fewer plastic pieces with a red colour will be present in a sorted group with green plastic pieces. The spectral imaging preferably comprises multispectral and/or hyperspectral imaging. In this way a full spectrum is acquired at each point, whereby the method requires no prior knowledge about the plastic piece. The spectral imaging is preferably near-infrared, NIR, spectroscopy. This increases the sorting speed, whereby the processing time necessary for recycling the plastics is reduced.

According to an embodiment, the dimensions of the plastic flakes are such that a maximum section D1 thereof is smaller than 20 mm, more preferably smaller than 12 mm, still more preferably smaller than 10 mm, most preferably smaller than 8 mm. Because the plastic flakes have a relatively small maximum section, the cross-link between the plastic flakes in the recycled good is improved. In this way the structural integrity of the recycled good is improved.

According to an embodiment, the step of shredding comprises a plurality of shredding steps. In this way the plastic flakes having a section greater than the maximum section D1 are made smaller still, into plastic flakes with a permitted maximum section. The maximum section of the plastic flakes is preferably verified after each shredding step, for instance by moving the shredded plastic flakes over a screen. The screen has a predetermined screen size which corresponds to the predetermined maximum allowed section D1. Plastic flakes with the predetermined maximum section D1 are thus obtained.

According to an embodiment, the micronized plastic is a thermoplastic powder, preferably a recycled thermoplastic powder. In this way the plastic flakes are processed into a recycled good in advantageous manner and use can be made of recycled thermoplastics in order to thus increase the quantity of recycled plastic in the recycled good. The method hereby provides an improved manner of recycling the different types of plastic.

According to an embodiment, the method further comprises of washing the plastic pieces and/or plastic flakes. The inventiveness of this solution is based inter alia on the insight that dirt particles and the like can disrupt the chemical bond in the recycled good. Owing to the washing, the surface of the plastic flakes is free from contaminants, whereby the bond in the recycled good is improved. The integrity of the recycled good is thus improved. The step of washing is preferably performed after the grinding of the plastic into plastic pieces. The chance of unwashed areas on the surface of the plastic pieces is reduced in this way. The plastic pieces and/or flakes are thus washed in improved manner.

According to an embodiment, the dimensions of the plastic pieces are such that a maximum section D2 thereof is greater than 50 mm, preferably greater than 75 mm, more preferably greater than 100 mm. In this way the method ensures that, during the step of sorting by colour, the size of the plastic pieces is sufficiently large for the plastic pieces to be sorted in efficient and rapid manner. An advantage hereof is based on the insight that plastic pieces which are not sufficiently large would require a computing and sorting capacity many times greater.

According to a second aspect of the invention, a recycling system is provided for recycling plastic, preferably recycling plastic toys, comprising:
a grinding device configured to grind the plastic into plastic pieces;
a sorting device configured to sort the plastic pieces based on type of plastic;
a further sorting device configured to sort the plastic pieces based on colour;
a shredding device configured to, after sorting of the plastic pieces, shred the sorted plastic pieces into plastic flakes;
a processing device configured to process the plastic flakes into a recycled good by means of rotational moulding, wherein a micronized plastic is added during the rotational moulding.

The skilled person will appreciate that advantages and objectives similar to those for the method apply for the corresponding system, mutatis mutandis.

### BRIEF DESCRIPTION OF THE FIGURES

The above and other advantageous features and objectives of the invention will become more apparent and the invention better understood with reference to the following detailed description when read in combination with the accompanying figures, in which:

FIG. 1 is a schematic overview of an embodiment of a method for recycling plastic, preferably recycling plastic toys, according to the invention;

FIG. 2 is an alternative embodiment of FIG. 1;

FIG. 3 is a schematic overview of an embodiment of the sorting of the plastic pieces based on type of plastic;

FIG. 4 is a schematic overview of an embodiment of the sorting of the plastic pieces based on colour;

FIG. 5 is a schematic overview of a preferred embodiment of a method for recycling plastic, preferably recycling plastic toys, according to the invention;

FIG. 6 is a schematic view of plastic pieces with a maximum section;

FIG. 7 is a schematic view of plastic flakes with a maximum section; and

FIG. 8 is a schematic view of an embodiment of a recycling system for recycling plastic, preferably recycling plastic toys, according to the invention.

### DETAILED EMBODIMENTS

The invention will now be further described with reference to exemplary embodiments shown in the figures. The same or similar elements are designated in the figures with the same reference numeral.

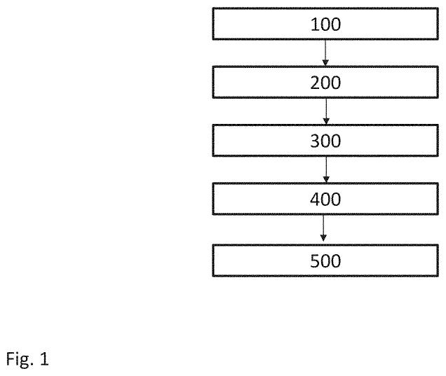

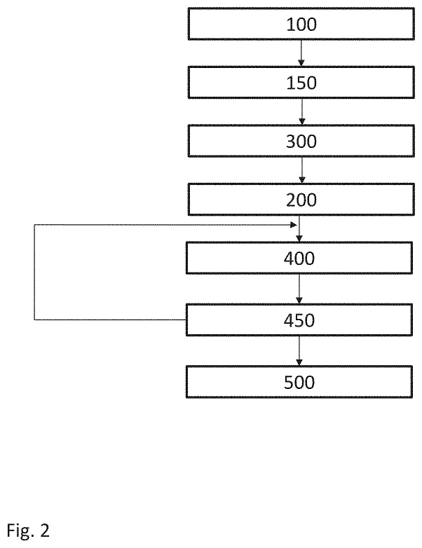

FIGS. 1 and 2 illustrate an embodiment of a method for recycling plastic according to the invention. FIG. 1 shows particularly a flowchart of the method, wherein the method comprises the following steps:
step 100 of grinding the plastic into plastic pieces 600;
step 200 of sorting the plastic pieces based on type of plastic;
step 300 of sorting the plastic pieces based on colour;
after sorting of the plastic pieces, the step 400 of shredding the sorted plastic pieces into plastic flakes 700;
step 500 of processing the plastic flakes into a recycled good by means of rotational moulding, wherein a micronized plastic is added during the rotational moulding.

According to an embodiment of the method for recycling plastic, the step 100 comprises of grinding the plastic into plastic pieces 600. In a preferred embodiment the plastic is plastic toys. It will be apparent to the skilled person that the grinding of the plastic can be performed by means of different types of grinding device, use can for instance be made of a horizontal or vertical hammer mill and so on. Step 100 is particularly performed by a grinding device wherein the plastic is ground into plastic pieces 600 with a desired minimum size. The minimum size of plastic pieces 600 corresponds to a maximum section D2 of the plastic pieces 600, such that this is preferably greater than 50 mm, preferably greater than 75 mm, more preferably greater than 100 mm. An advantage hereof his based on the insight that plastic, and particularly plastic toys, often comprise components which are made from different colours. The plastic components, which are coupled or attached to each other, can be detached from each other in simple manner by the grinding. A further advantage is that because the plastic pieces comprise a determined minimum size, the step 300 of sorting the plastic pieces by colour can thus take place rapidly and thoroughly.

Step 200 of the method comprises of sorting the plastic pieces 600 based on type of plastic. It will be apparent to the skilled person that the sorting of the plastic pieces 600 based on type can be carried out by means of different techniques. The plastic pieces can thus for instance be sorted based on density in order to thus obtain the desired material type of plastic. According to a preferred embodiment of the method, the plastic pieces are sorted by means of an optical Near-Infrared, NIR, sorting device.

Step 300 of the method comprises of sorting the plastic pieces 600 based on colour of the plastic pieces. According to a preferred embodiment, the step 300 is performed by an optical sorting device. The colour of the plastic pieces is preferably determined by means of spectral imaging. Spectral imaging is imaging which makes use of one or more wavelength bands in the electromagnetic spectrum. A normal camera typically captures light across three wavelength bands in the visible spectrum, red, green and blue, RGB. Spectral imaging comprises a wide variety of techniques that go beyond RGB. Spectral imaging can map the infrared spectrum, the visible spectrum, the ultraviolet spectrum, x-rays or a combination of the above spectra. The spectral imaging preferably comprises multispectral and/or hyperspectral imaging. An advantage of multispectral and/or hyperspectral imaging is that image data can be collected in visible and non-visible wavelength bands simultaneously. A further advantage is that use can be made of illumination from outside the visible range, or of optical filters for capturing a specific spectral range. Multispectral imaging typically relates to the capturing of at least three wavelength bands to about ten wavelength bands. Hyperspectral imaging typically relates to the capturing of hundreds of wavelength bands. A resolution of each wavelength band, and a width thereof, can be adjusted depending on the application. The spectral imaging is preferably Near-Infrared, NIR, spectroscopy. NIR spectroscopy makes use of infrared, IR, radiation. This IR radiation is directed at the plastic piece to be examined. The plastic piece lets through a part of this radiation, absorbs a part, and can reflect this radiation. From this, a spectrum is created which shows which wavelengths were absorbed or conversely let through. The materials and/or colours in question can then be determined based on this spectrum, since each molecule will absorb this radiation in a different way. NIR spectroscopy provides the advantage that it can be used both for sorting by type of plastic of the plastic pieces and for sorting by colour of the plastic pieces. A further advantage of NIR spectroscopy is that the colour can be determined rapidly and accurately in advantageous manner.

Step 400 of the method comprises, after sorting of the plastic pieces, of shredding the sorted plastic piece into plastic flakes. The step 400 of shredding must be performed after steps 200 and 300. The shredding can be performed by different shredding devices. The shredding device can be similar to the grinding device of step 100. Alternatively, the shredding device can differ from the grinding device of step 100 in that the plastic pieces are shredded into plastic flakes, wherein the plastic flakes have dimensions with a maximum section D1. The maximum section D1 is preferably smaller than 20 mm, more preferably smaller than 12 mm, still more preferably smaller than 10 mm, most preferably smaller than 8 mm. In an embodiment the size of the plastic flakes can be verified 450 by means of a screen (shown in FIG. 2). The screen can for instance be a trommel screen or a vibrating screen, wherein the screen has a passage size or screen size which corresponds to the maximum section D1 of the plastic flakes.

Step 500 of the method comprises of processing plastic flakes into a recycled good by means of rotational moulding, wherein a micronized plastic is added during the rotational moulding. In a first processing step the flakes are placed in a mould of a rotational moulding device. Depending on the object of the recycled good, a desired quantity of micronized plastic is added. By rotating the rotational moulding device the plastic flakes will mix with the micronized plastic. The mould is rotated in an oven or, in an alternative embodiment, can also comprise heating elements itself. When the mould is heated, the micronized plastic will melt and form the bond between the plastic flakes. The mould rotates along two mutually perpendicular axes, whereby the melted material is pressed against the mould wall and takes on the shape of the mould. A recycled good is thus obtained. Research has shown that in some cases the use of plastic flakes results in recycled goods with poor structural properties. Because the molecules cannot move relative to each other, bonds can no longer be created during recycling of the plastic. Owing to the rotational moulding, the wall thickness of the recycled good can be determined and the melted micronized plastic will surround the plastic flakes during the rotational moulding, whereby an improved structural integrity of the recycled good is obtained.

FIG. 2 shows a similar flowchart of a method shown in FIG. 1 according to the invention. The method is similar to the method shown in FIG. 1. FIG. 1 shows particularly that the steps of grinding 100, sorting by type 200 and sorting by colour 300 are successive. It will however be apparent that the steps 200 and 300, as shown in FIG. 2, are interchangeable in an alternative embodiment. FIG. 2 further shows that step 300 and step 200 can be preceded by the step 150 of washing the plastic. Plastic, and particularly plastic toys, can be contaminated by attached contaminants such as sand, dust, oil and so on. The further steps of the method can hereby be impeded or hampered. The structural integrity of the recycled good can further also deteriorate. By performing the step of washing before the steps of sorting false positives in the sorting are avoided and the structural integrity of the recycled good is improved.

In an alternative embodiment the size of the plastic flakes can be verified 450 by means of a screen after the step 400 of the shredding into plastic flakes. When the size of a plastic flake or a plurality of plastic flakes does not meet requirements, they can once again undergo the step 400 of shredding so as to ultimately comply with the predetermined size, as described with reference to FIG. 1.

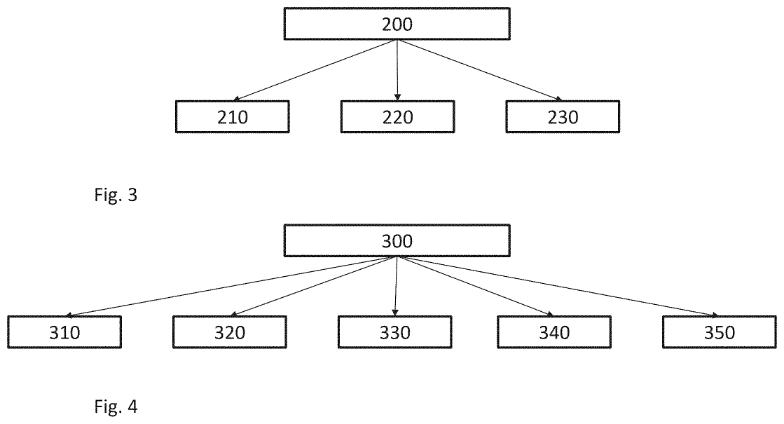

FIGS. 3 and 4 illustrate an embodiment of a part of the method for recycling plastic according to the invention. The figures particularly show that the sorting of the plastic pieces in step 200 and 300 comprises of subdividing the plastic pieces into groups according to a type 210, 220, 230, and so on and/or a colour 310, 320, 330, 340, 350. Each group has plastic pieces which are substantially of the same type of plastic and/or colour as each other.

FIG. 3 illustrates particularly that the step 200 of sorting of the plastic pieces based on type of plastic comprises of subdividing the plastic pieces into groups according to a type 210, 220, 230. The groups comprise plastic pieces of substantially the same type. Plastic can typically be subdivided into three types: thermoplastics, thermosets and elastomers. The group 210 in the method corresponds for instance to the type thermosets, the group 220 to the type thermoplastics and the group 230 to the type elastomers. It will be apparent to the skilled person that, after sorting, the groups are separated from each other. The sorting of plastic according to type is described in the step 300 of FIG. 1. In an alternative embodiment the sorting by type of plastic can take place by means of float-sink density separation. Float-sink density separation is based on a difference in density between the different types of plastic and a density of a liquid in a separation container. Depending on the density of the plastics, they will float or sink in the liquid. The floating and the sunk plastics can then be removed from the separation container in succession. The plastics can thus be mutually separated from each other. The liquids used in the separation container can be selected depending on the types of plastic.

FIG. 4 illustrates that the step 300 of sorting of the plastic pieces based on colour comprises of subdividing the plastic pieces into groups according to a colour 310, 320, 330, 340, 350. The groups comprise plastic pieces of substantially the same colour. The group 310 for instance corresponds to the colour red, the group 320 corresponds to the colour green and the group 330 for instance corresponds to the colour blue. It will be apparent to the skilled person that the plastic pieces can also be sorted according to many other colours, for instance purple, orange, yellow and so on, and that the number of groups illustrated in FIG. 4 is not limitative to the sorting. It will be apparent to the skilled person that the groups are separated from each other after the sorting.

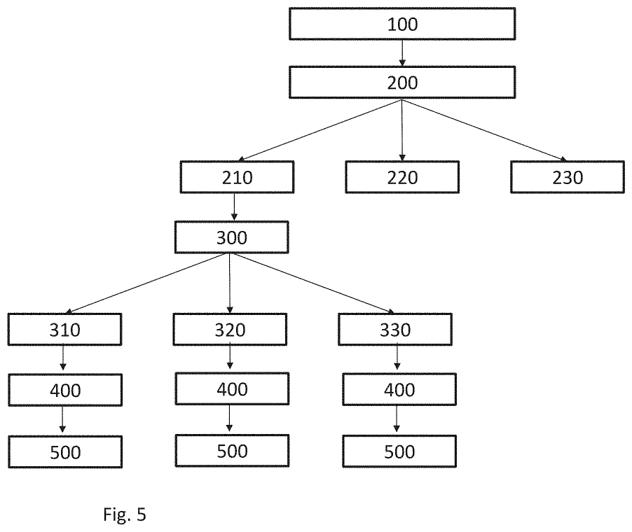

FIG. 5 illustrates a preferred embodiment of the method according to the invention. FIG. 5 particularly illustrates that the groups of plastic pieces, which were sorted according to type 210, 220, 230 or colour 310, 320, 330, can go through the further subsequent steps as groups. The method can thus for instance first sort the plastic pieces by type of plastic 210, 220, 230, and then further sort the type 210, which for instance corresponds with thermosets, by a colour 310, 320, 330, 340, 350. As shown in FIG. 1, the plastic first goes through the step 100 of grinding of the plastic into plastic pieces 600. The plastic pieces are then preferably sorted by type of plastic into groups 210, 220, 230 which comprise substantially the same type of plastic. In a preferred embodiment the group 210 which corresponds with plastic parts of the thermosets type is then sorted by colour in the step 300. The plastic pieces are thus sorted into groups comprising plastic pieces with substantially the same colour. The group 210 can for instance be sorted according to three colours: red 310, blue 320, green 330. Each group will then be shredded in step 400 into plastic flakes and be processed in step 500 into a recycled good. It will be apparent that the alternative embodiments illustrated in FIG. 2 can also be applied in the method of FIG. 5.

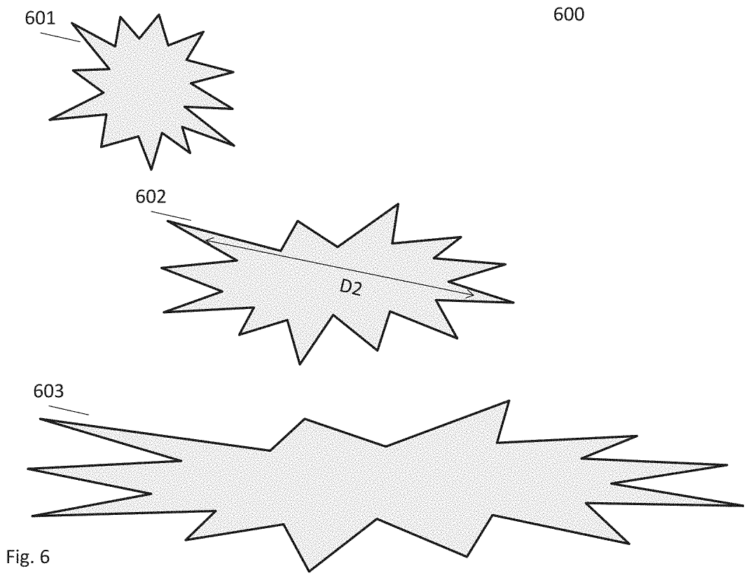

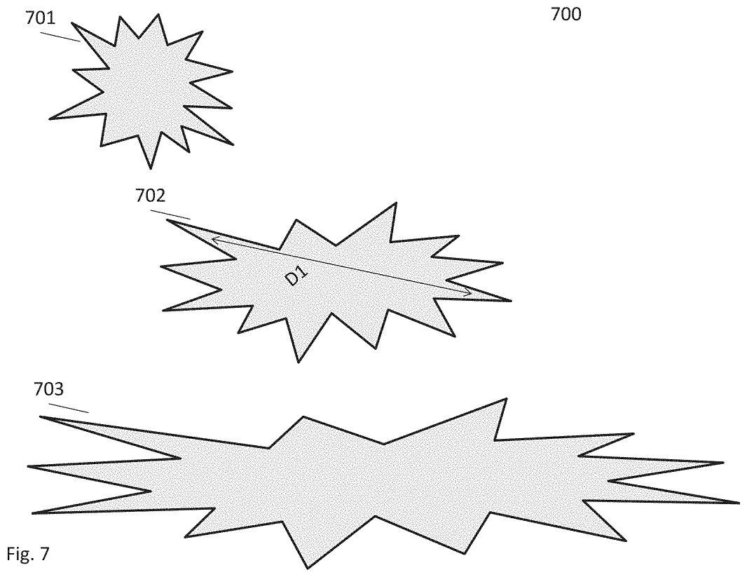

FIGS. 6 and 7 show plastic pieces 601, 602, 603 or plastic pieces 701, 702, 703. The plastic pieces are obtained after the step 100 of grinding. The step 100 is particularly performed by a grinding device, wherein the plastic is ground into plastic pieces 600 with a desired minimum size. The minimum size of plastic pieces 600 corresponds to a maximum section D2 of the plastic pieces 600, such that this section can be inscribed in a circle with a diameter which is preferably greater than 50 mm, preferably greater than 75 mm, more preferably greater than 100 mm. It will be apparent that the plastic parts have different shapes.

FIG. 7 is similar to FIG. 6 and shows that, after the step 400 of shredding, the plastic flakes 701, 702, 703, similar to the plastic pieces, have a maximum size corresponding with a maximum section D1 of the plastic flakes, such that this section is preferably smaller than 20 mm, more preferably smaller than 12 mm, still more preferably smaller than 10 mm, most preferably smaller than 8 mm. The step 450 of verifying, which is illustrated in FIG. 2, can be performed in both cases.

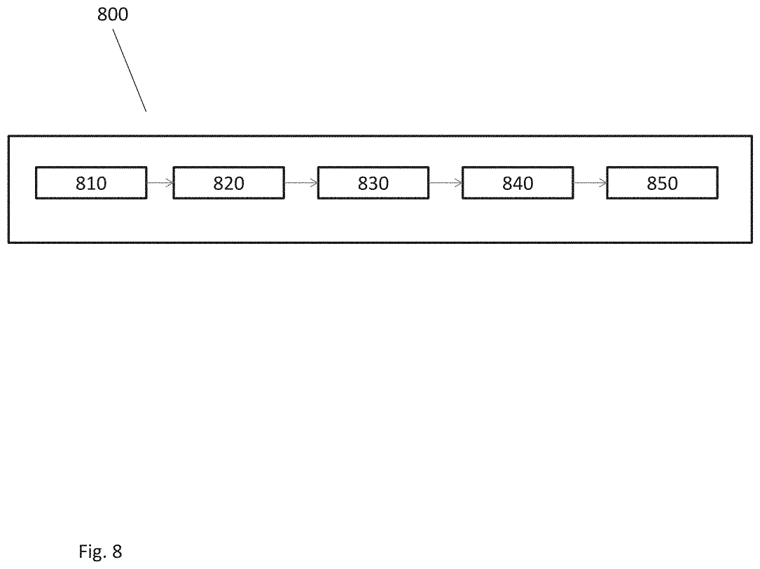

FIG. 8 shows a recycling system 800 for recycling plastic, preferably recycling plastic toys, comprising a grinding device 810 which is configured to grind the plastic into plastic pieces, a first sorting device 820 configured to sort the plastic pieces based on type of plastic, a further sorting device 830 configured to sort the plastic pieces based on colour, a shredding device 840 configured to shred the sorted plastic pieces, after sorting of the plastic pieces, into plastic flakes, and a processing device 850 configured to process the plastic flakes into a recycled good by means of rotational moulding, wherein a micronized plastic is added during the rotational moulding.

The skilled person will appreciate based on the above description that the invention can be embodied in different ways and based on different principles. The invention is not limited to the above described embodiments. The above described embodiments and the figures are purely illustrative and serve only to increase understanding of the invention. The invention will not therefore be limited to the embodiments described herein, but is defined in the claims.

1. A method for recycling plastic, wherein the method comprises:
grinding the plastic into plastic pieces;
sorting the plastic pieces based on type of plastic;
sorting the plastic pieces based on colour;
after sorting of the plastic pieces, shredding the sorted plastic pieces into plastic flakes;
washing the plastic pieces and/or plastic flakes, wherein the step of washing is performed after grinding of the plastic into plastic pieces; and
processing the plastic flakes into a recycled good by means of rotational moulding, wherein, during the rotational moulding, a micronized plastic is added.

2. The method according to claim 1, wherein the sorting of the plastic pieces based on colour comprises of subdividing the plastic pieces into groups according to a colour, wherein each group comprises plastic pieces having substantially the same colour as each other.

3. The method according to claim 2, wherein the colour of the plastic pieces is determined by means of spectral imaging.

4. The method according to claim 3, wherein the spectral imaging comprises multispectral and/or hyperspectral imaging.

5. The method according to claim 3, wherein the spectral imaging is near-infrared, NIR, spectroscopy.

6. The method according to claim 1, wherein the dimensions of the plastic flakes are such that a maximum section D₁ thereof is smaller than 20 mm.

7. The method according to claim 1, wherein the step of shredding comprises a plurality of shredding steps.

8. The method according to claim 1, wherein the micronized plastic is a thermoplastic powder.

9. The method according to claim 1, wherein the dimensions of the plastic pieces are such that a maximum section D₂ thereof is greater than 50 mm.

10. A recycling system for recycling plastic, comprising:
a grinding device configured to grind the plastic into plastic pieces;
a first sorting device configured to sort the plastic pieces based on type of plastic;
a further sorting device configured to sort the plastic pieces based on colour;
a shredding device configured to, after sorting of the plastic pieces, shred the sorted plastic pieces into plastic flakes; and
a processing device configured to process the plastic flakes into a recycled good by means of rotational moulding, wherein a micronized plastic is added during the rotational moulding.
